(19) United States
(12) Patent Application Publication
(10) Pub. No.: US 2021/0203842 A1
(43) Pub. Date: Jul. 1, 2021

(54) PANORAMIC VIDEO PROCESSING METHOD, PANORAMIC VIDEO PROCESSING DEVICE AND PANORAMIC VIDEO SYSTEM

(71) Applicant: INDUSTRIAL TECHNOLOGY RESEARCH INSTITUTE, Hsinchu (TW)

(72) Inventors: Jih-Sheng TU, Yilan City (TW); Kai-Shun LIN, Sanxing Township (TW); Po-Kai LIU, Caotun Township (TW); Chung-Yu LIAO, Hsinchu City (TW)

(73) Assignee: INDUSTRIAL TECHNOLOGY RESEARCH INSTITUTE, Hsinchu (TW)

(21) Appl. No.: 16/728,939

(22) Filed: Dec. 27, 2019

(51) Int. Cl. H04N 5/232; G01S 3/786; G02B 27/01

(52) U.S. Cl. CPC H04N 5/23238; H04N 5/232945; G02B 2027/0123; G02B 27/0172; G01S 3/7865

(57) ABSTRACT

A panoramic video processing method, a panoramic video processing device and a panoramic video system are provided. The panoramic video processing method includes the following steps. A plurality of shooting ranges of a plurality of cameras and a field of view (FOV) are received. An amount of stitches of a plurality of original images is calculated according to the shooting ranges and the field of view. An amount of a plurality of adjacent parts of the original images is corresponding to the amount of stitches. The adjacent parts of the original images are stitched to obtain a plurality of partial panoramic images.

### TECHNICAL FIELD

The disclosure relates in general to a panoramic video processing method, a panoramic video processing device and a panoramic video system.

### BACKGROUND

In the conventional panoramic image processing method, all of the original images are stitched to obtain one panoramic image. Then, the panoramic image is divided for displaying according to the need of the end user. However, all of the original images are needed to be stitched. The stitches are performed sequentially and cannot be performed in parallel, such that the process cannot be speeded up.

Especially, for the application of the panoramic video, if the processing speed of panoramic video is low, the frame rate of the panoramic video will be reduced, and it cannot be applied for the real time application. Therefore, how to speed up the process of the panoramic video is an important issue.

Moreover, the end users have various processing capability, and the panoramic video may be more than 8 k or 16 k. Because the bandwidth is limited, the transmission time is needed to be reduced for all users to bring a good high-resolution panoramic viewing experience.

### SUMMARY

The disclosure is directed to a panoramic video processing method, a panoramic video processing device and a panoramic video system.

According to one embodiment, a panoramic video processing method is provided. The panoramic video processing method includes the following steps. A plurality of shooting ranges of a plurality of cameras and a field of view (FOV) are received. An amount of stitches of a plurality of original images is calculated according to the shooting ranges and the field of view. An amount of a plurality of adjacent parts of the original images is corresponding to the amount of stitches. The adjacent parts of the original images are stitched to obtain a plurality of partial panoramic images.

According to another embodiment, a panoramic video processing device is provided. The panoramic video processing device includes a controlling unit and a plurality of processing units. The controlling unit is used for receiving a plurality of shooting ranges of a plurality of original images and a field of view (FOV), and calculating an amount of stitches of the original images. An amount of a plurality of adjacent parts of the original images is corresponding to the amount of stitches. The processing units are used for stitching the adjacent parts of the original images some of the original to obtain a plurality of partial panoramic images.

According to an alternative embodiment, a panoramic video system is provided. The panoramic video system includes a panoramic photography device and a panoramic video processing device. The panoramic photography device includes a plurality of cameras and a panoramic video processing device. The panoramic video processing device includes a controlling unit and a plurality of processing units. The controlling unit is used for receiving a plurality of shooting ranges of a plurality of original images and a field of view (FOV), and calculating an amount of stitches of the original images. An amount of a plurality of adjacent parts of the original images is corresponding to the amount of stitches. The processing units are used for stitching the adjacent parts of the original images to obtain a plurality of partial panoramic images.

### BRIEF DESCRIPTION OF THE DRAWINGS

FIG. 1 shows a panoramic video processing architecture according to one embodiment.

FIG. 2 shows a panoramic image.

FIG. 3 shows a panoramic video system according to one embodiment.

FIG. 4 shows a flowchart of a panoramic video processing method according to one embodiment.

FIG. 5 illustrates 8 shooting ranges of 8 cameras.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Several embodiments are described here to illustrate the panoramic video processing method of the present application. The processing of the panoramic video is speeded up and the transmission time of all users are reduced to bring a good high-resolution panoramic viewing experience.

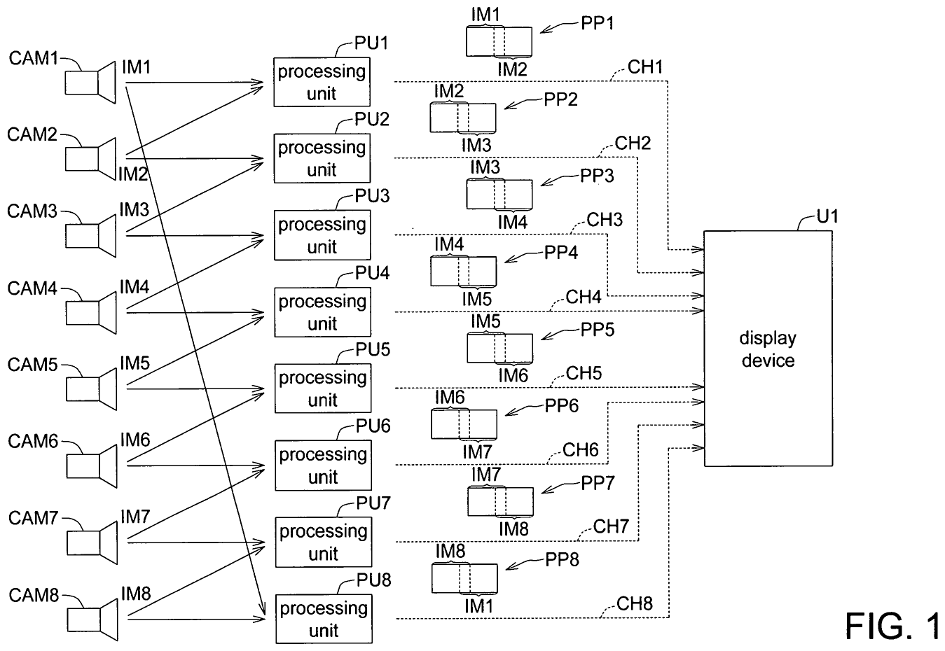

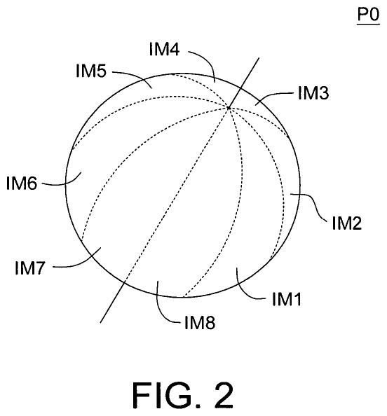

Please referring to FIGS. 1 and 2, FIG. 1 shows a panoramic video processing architecture according to one embodiment, and FIG. 2 shows a panoramic image P0. In the example of FIG. 1, a plurality of cameras CAM1 to CAM8 respectively capture a plurality of original images IM1 to IM8. In FIG. 1, the original images IM1 to IM8 are not directly stitched to be the panoramic image P0 of FIG. 2. Instead, the original images IM1 to IM8 are transmitted to a plurality of processing units PU1 to PU8. For example, the original images IM1, IM2 are transmitted to the processing unit PU1, the original images IM2, IM3 are transmitted to the processing unit PU2, the original images IM3, IM4 are transmitted to the processing unit PU3, and so on. The original images IM8, IM1 are transmitted to the processing unit PU8. The processing unit PU1 stitches only two original images IM1, IM2 to obtain a partial panoramic images PP1, the processing unit PU2 stitches only two original images IM2, IM3 to obtain a partial panoramic images PP2, the processing unit PU3 stitches only two original images IM3, IM4 to obtain a partial panoramic images PP3, and so on. The processing unit PU8 stitches only two original images IM8, IM1 to obtain a partial panoramic images PP8. The processing units PU1 to PU8 are performed in parallel, so the processing can be speeded up.

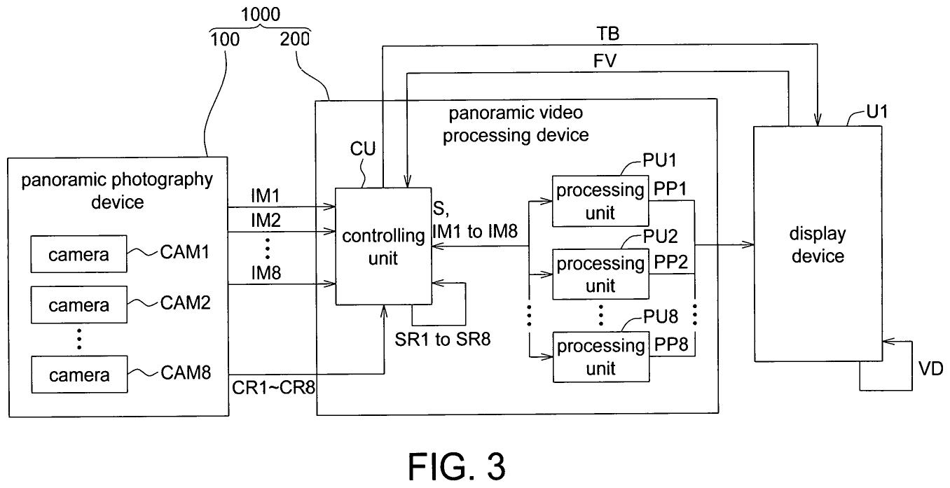

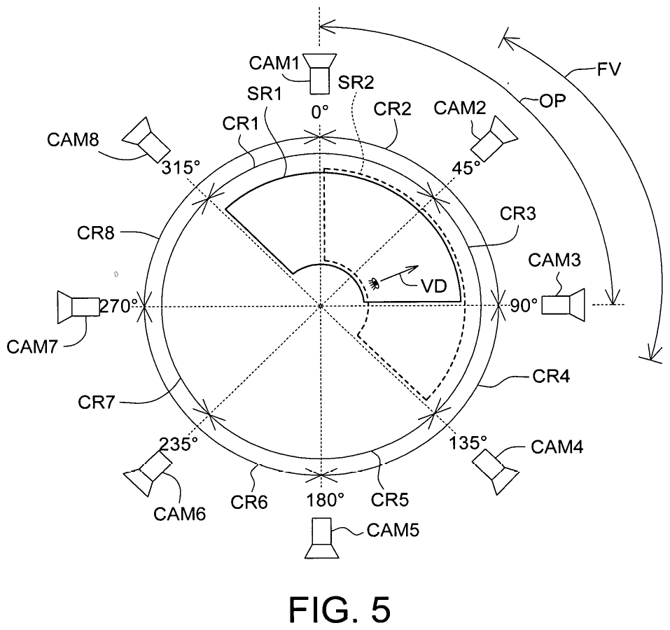

The partial panoramic images PP1 to PP8 are transmitted via a plurality of channels CH1 to CH8 respectively. Only one of the partial panoramic images PP1 to PP8, based on a view direction VD (shown in FIGS. 3 and 5), is transmitted via one of the channels CH1 to CH8 to a display device U1 to display. For example, the display device U1 is a head mounted display, a smart cell phone or a tablet. For displaying the panoramic video, the end user only needs to download one of the partial panoramic images PP1 to PP8, such that the transmission time can be greatly reduced.

In FIG. 1, 8 cameras CAM1 to CAMS, 8 processing units PU1 to PU8, and 8 channels CH1 to CH8 are used to illustrate the panoramic video processing architecture. However, the amount of the cameras, the amount of the processing units, and the amount of the channels are not limited to the present disclosure.

Please refer to FIG. 3, which shows a panoramic video system 1000 according to one embodiment. The panoramic video system 1000 includes a panoramic photography device 100 and a panoramic video processing device 200. For example, the panoramic photography device 100 is a 360-degree camera. For example, the panoramic video processing device 200 is a cluster computing system, an edge computing system, or a multi-cores server/computer. The panoramic photography device 100 and the panoramic video processing device 200 may be disposed at different places and communicate via the network. Or, the panoramic photography device 100 and the panoramic video processing device 200 may be integrated into one device and communicate via internal circuits.

The panoramic photography device 100 includes the cameras CAM1 to CAMS. The amount of the cameras may be larger than or equal to 2. The panoramic video processing device 200 includes a controlling unit CU and the processing units PU1 to PU8. The amount of the processing units may be less than or equal to the amount of the cameras. Each of the controlling unit CU and the processing units PU1 to PU8 may be a processor, a circuit, a chip, a circuit board, a processing core, a program module or a storage device storing program codes. The operation of those elements is illustrated by a flowchart as below.

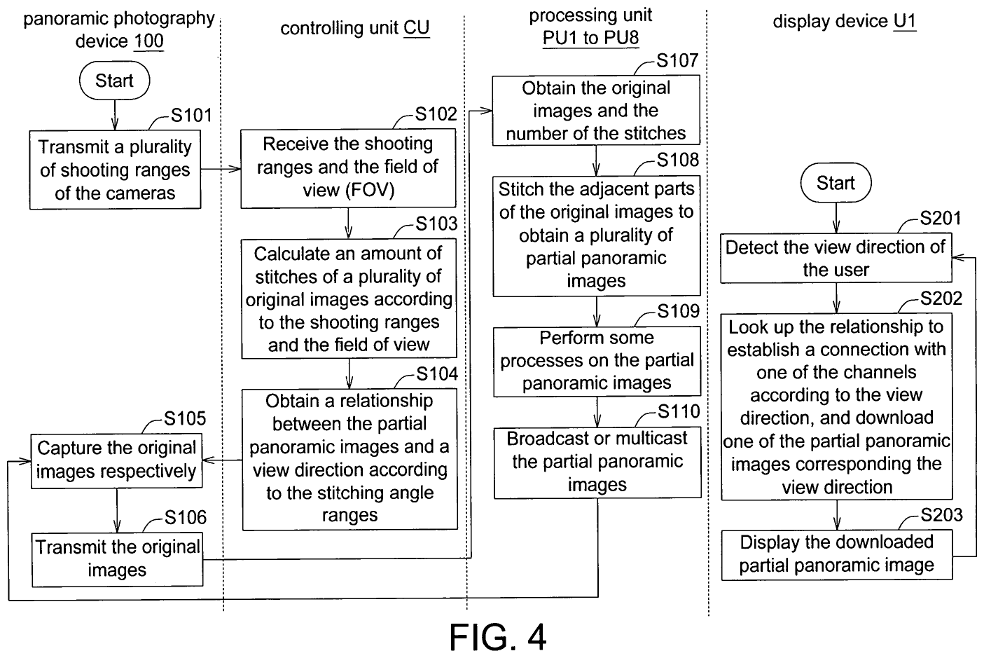

Please referring to FIG. 4, which shows a flowchart of the panoramic video processing method according to one embodiment. The order of the steps in the flowchart is not used to limit the present disclosure. The steps S101 to S104 are a stitch strategy creating procedure, which can be performed at off-line. The steps S105 to S110 are a stitch performing procedure, which can be performed at on-line. The steps S201 to S203 are a download procedure.

The stitch strategy creating procedure (steps S101 to S104) is illustrated first. At step S101, the panoramic photography device 100 transmits a plurality of shooting ranges CR1 to CR8 of the cameras CAM1 to CAM8. For example, please refer to FIG. 5, which illustrates the 8 shooting ranges CR1 to CR8 of the 8 cameras CAM1 to CAM8. In the 8 cameras CAM1 to CAM8, each of the shooting ranges CR1 to CR8 of the cameras CAM1 to CAM8 is 90 degrees. For example, the shooting range CR1 of the camera CAM1 is from 315 degrees to 45 degrees, the shooting range CR2 of the camera CAM2 is from 0 degree to 90 degrees, the shooting range CR3 of the camera CAM3 is from 45 degrees to 135 degrees, and so on.

Then, in the step S102, the controlling unit CU receives the shooting ranges CR1 to CR8 and the field of view (FOV) FV of the display device U1. Different display devices may have different FOV. In general, the FOV of the head mounted display may be 80 to 110 degrees. The user may zoom in or zooms out the frame to reduce or enlarge the FOV.

Next, in step S103, the controlling unit CU calculates an amount S of stitches of the original images IM1 to IM8 according to the shooting ranges CR1 to CR8 and the field of view FV. An amount of a plurality of adjacent parts of the original images IM1 to IM8 is corresponding to the amount of stitches. If the amount S is 2, it means that two original images of two cameras which are adjacent are stitched to be a partial panoramic image; if the amount S is 3, it means that three original images of three cameras which are adjacent are stitched to be a partial panoramic image; and so on. The amount S of stitches may be temporarily stored in a storage unit. The amount S of stitches is an integer which is larger than or equal to 2. For example, in the example of FIG. 5, the amount S of stitches is 2. The original images IM1 of the camera CAM1 and the original image IM2 of the camera CAM2 are stitched to be a partial panoramic images PP1 (shown in FIGS. 1, 3), whose stitching angle range SR1 is from 315 degrees to 90 degrees; the original images IM2 of the camera CAM2 and the original image IM3 of the camera CAM3 are stitched to be a partial panoramic images PP2 (shown in FIGS. 1, 3), whose stitching angle range SR2 is from 0 degree to 135 degrees, and so on.

As shown in FIG. 5, each of the stitching angle range SR1, SR2, . . . is larger than the field of view FV, such that only one of the partial panoramic images PP1 to PP8 is needed to be downloaded by the display device U1 to fully fill the field of view FV.

Besides, as shown in FIG. 5, an overlapping angel range OP of two of the partial panoramic images PP1 to PP8 (shown in FIG. 3) which is adjacent is larger than the field of view FV, such that the partial panoramic images PP1 to PP8 can be seamless switched when the user's head is rotated.

Moreover, if the amount S of stitches is 2, N partial panoramic images can be obtained from N original images; if the amount S of stitches is 3, N−1 partial panoramic images can be obtained from N original images; if the amount S of stitches is 4, N−2 partial panoramic images can be obtained from N original images, and so on.

Afterwards, in step S104, the controlling unit CU obtains a relationship TB between the partial panoramic images PP1 to PP8 and a view direction VD according to the stitching angle ranges SR1, SR2, . . . . Base on the steps S101 to S104, the stitch strategy creating procedure is completed. Taken table I as an example, the table I illustrates the relationship TB. The relationship TB can be integrated into a meta-data packet.

TABLE I

| view direction VD | partial panoramic image | channel |
|---|---|---|
| 1 degree to 45 degrees | partial panoramic image | channel CH1 |
| | PP1 | |
| 46 degrees to 90 degrees | partial panoramic image | channel CH2 |
| | PP2 | |
| 91 degrees to 135 degrees | partial panoramic image | channel CH3 |
| | PP3 | |
| 136 degrees to 180 degrees | partial panoramic image | channel CH4 |
| | PP4 | |
| 181 degrees to 225 degrees | partial panoramic image | channel CH5 |
| | PP5 | |
| 226 degrees to 270 degrees | partial panoramic image | channel CH6 |
| | PP6 | |
| 271 degrees to 315 degrees | partial panoramic image | channel CH7 |
| | PP7 | |
| 316 degrees to 0 degree | partial panoramic image | channel CH8 |
| | PP8 | |

Next, the stitch performing procedure, i.e. the steps S105 to S110, is illustrated. In the step S105, the cameras CAM1 to CAM8 of the panoramic photography device 100 capture the original images IM1 to IM8 respectively.

Then, in step S106, the panoramic photography device 100 transmits the original images IM1 to IM8 to the panoramic video processing device 200.

Next, in step S107, the processing units PU1 to PU8 obtain the original images IM1 to IM8 and the amount S of stitches.

Then, in step S108, the processing units PU1 to PU8 stitch the adjacent parts of the original images IM1 to IM8 to obtain the partial panoramic images PP1 to PP8. In this step, the processing units PU1 to PU8 are performed in parallel to obtain the partial panoramic images PP1 to PP8 at the same time. Therefore, the time for stitching can be reduced to ⅛.

Next, in step S109, the processing units PU1 to PU8 perform some processes, such as coding or rending, on the partial panoramic images PP1 to PP8.

Afterwards, in the step S110, the partial panoramic images PP1 to PP8 are transmitted via broadcast or multicast for the user to download. Through the steps S105 to S110, the stitch performing procedure is completed. In the present embodiment, due to the parallel processing, the processing speed of the stitch performing procedure can be greatly improved. Therefore, the frame rate of the panoramic video is not reduced and can be applied for the real time application.

Next, the download procedure, i.e. the steps S201 to S203, is illustrated. In step S201, the display device U1 detects the view direction VD of the user. For example, the display device U1 may equipped with a gyroscope, a compass, a G-sensor, an outside-in tracking system, or an inside-out tracking system to detect the view direction VD.

Then, in step S202, the relationship TB is looked up to establish a connection with one of the channels CH1 to CH8 according to the view direction VD, and one of the partial panoramic images PP1 to PP8 corresponding the view direction VD is downloaded.

Next, in step S203, the display device U1 displays the downloaded partial panoramic image (one of the partial panoramic images PP1 to PP8). Through the steps S201 to S203, the download procedure is completed. In the present embodiment, due to the partial panoramic images PP1 to PP8, each user does not download whole of the panoramic image P0. The bandwidth is not occupied to much and the transmission time is reduced to bring a good high-resolution panoramic viewing experience.

According to the embodiments described above, the parallel processing technology and broadcast/multicast technology are used to improve the processing speed of the panoramic video and reduce the transmission time for all users. As such, in the 360-degrees Virtual Reality Ultra High Resolution (16K) application, there is no encoding/decoding/display latency. The head mounted display can achieve 4K display capability and display 16K picture.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A panoramic video processing method, comprising:
receiving a plurality of shooting ranges of a plurality of cameras and a field of view (FOV);
calculating an amount of stitches of a plurality of original images according to the shooting ranges and the field of view, wherein an amount of a plurality of adjacent parts of the original images is corresponding to the amount of stitches; and
stitching the adjacent parts of the original images to obtain a plurality of partial panoramic images.

2. The panoramic video processing method according to claim 1, wherein a stitching angle range of each of the partial panoramic images is larger than the field of view.

3. The panoramic video processing method according to claim 1, wherein an overlapping angel range of two of the partial panoramic images which are adjacent is larger than field of view.

4. The panoramic video processing method according to claim 1, wherein a plurality of stitching angle ranges of the partial panoramic images are identical.

5. The panoramic video processing method according to claim 1, wherein an amount of the original images is larger than the amount of stitches.

6. The panoramic video processing method according to claim 1, further comprising:
obtaining a relationship between the partial panoramic images and a view direction according to a plurality of stitching angle ranges.

7. The panoramic video processing method according to claim 6, wherein the partial panoramic images are transmitted via a plurality of channels, and the panoramic video processing method further comprises:
detecting the view direction; and
looking up the relationship to establish a connection with one of the channels according to the view direction.

8. A panoramic video processing device, comprising:
a controlling unit, used for receiving a plurality of shooting ranges of a plurality of original images and a field of view (FOV), and calculating an amount of stitches of the original images, wherein an amount of a plurality of adjacent parts of the original images is corresponding to the amount of stitches; and
a plurality of processing units, used for stitching the adjacent parts of the original images to obtain a plurality of partial panoramic images.

9. The panoramic video processing device according to claim 8, wherein a stitching angle range of each of the partial panoramic images is larger than the field of view.

10. The panoramic video processing device according to claim 8, wherein an overlapping angel range of two of the partial panoramic images which are adjacent is larger than field of view.

11. The panoramic video processing device according to claim 8, wherein a plurality of stitching angle ranges of the partial panoramic images are identical.

12. The panoramic video processing device according to claim 8, wherein an amount of the original images is larger than the amount of stitches.

13. The panoramic video processing device according to claim 8, wherein the controlling unit is further used for obtaining a relationship between the partial panoramic images and a view direction according to a plurality of stitching angle ranges.

14. The panoramic video processing device according to claim 13, wherein the partial panoramic images are transmitted via a plurality of channels.

15. A panoramic video system, comprising:
a panoramic photography device, including a plurality of cameras; and
a panoramic video processing device, including:
a controlling unit, used for receiving a plurality of shooting ranges of a plurality of original images and a field of view (FOV), and calculating an amount of stitches of the original images, wherein an amount of a plurality of adjacent parts of the original images is corresponding to the amount of stitches; and
a plurality of processing units, used for stitching the adjacent parts of the original images to obtain a plurality of partial panoramic images.

16. The panoramic video system according to claim 15, wherein a stitching angle range of each of the partial panoramic images is larger than the field of view.

17. The panoramic video system according to claim 15, wherein an overlapping angel range of two of the partial panoramic images which are adjacent is larger than field of view.

18. The panoramic video system according to claim 15, wherein a plurality of stitching angle ranges of the partial panoramic images are identical.

19. The panoramic video system according to claim 15, wherein an amount of the original images is larger than the amount of stitches.

20. The panoramic video system according to claim 15, wherein the controlling unit is further used for obtaining a relationship between the partial panoramic images and a view direction according to a plurality of stitching angle ranges.

21. The panoramic video system according to claim 20, wherein the partial panoramic images are transmitted via a plurality of channels.
